(19) United States
(12) Patent Application Publication
(10) Pub. No.: US 2006/0219967 A1
(43) Pub. Date: Oct. 5, 2006

(54) Pressure-difference adjustable venturi tube device

(76) Inventor: Chi-Chang Wang, Taipei Hsien (TW)

Correspondence Address: Chi-Chang Wang, 235 Chung-Ho, Box 8-24, Taipei, TW

(21) Appl. No.: 11/098,634

(22) Filed: Apr. 5, 2005

(51) Int. Cl. F16K 47/00

(52) U.S. Cl. 251/124

(57) ABSTRACT

A pressure-difference adjustable Venturi tube device compises a Venturi tube having an inlet, a hollow tapered compressing channel, an injection opening communicated to the compressing channel, a mixing chamber communicated to the injection opening, and an outlet communicated to the mixing chamber, which are sequentially arranged one by one; a negative pressure stub extended from the connection of the injection opening and the mixing chamber to a lateral side of the Venturi tube so as to communicated to outer sides; and a control valve installed from the inlet of the Venturi tube to the distal end of the injection opening for controlling a tube size of the injection opening of the compressing channel. The control valve is one of an electric controlled and a manual controlled ball valve and other control element.

### FIELD OF THE INVENTION

The present invention relates to Venturi tubes, and in particular to a pressure-difference adjustable Venturi tube device, wherein the pressure difference of the inlet and outlet of the Venturi tube is adjustable to fit the requirement. Furthermore, the present invention has a control valve. The size of the injection opening is controlled by the control valve easily so that the pressure difference between the inlet and the outlet of the Venturi tube 1 is controllable according to the usage, environment, positions and input pressure.

### BACKGROUND OF THE INVENTION

Venturi tubes are widely used in industry, specifically in the mixing of ozone and other fluid for sterilizing and deodorization. Furthermore, it is well know that by the pressure difference between the inlet and outlet of the Venturi tube so as to have a negative pressure absorption for absorbing adding gas to mix with other object for outputting.

As the pressure difference of the Venturi tube changes, the negative pressure of the negative pressure stub is also changed. If the input pressure is small, the negative pressure is smaller. Thereby the negative pressure of the Venturi tube is changed with the application and environment. For example, it has different pressures as the Venturi tube is installed to a section with great water pressure and to another section with small water pressure. Thereby the fixed type Venturi tube is not an ideal one.

An auxiliary device can be used to control the volume of the input gas, for example, to measure the gas by using a negative pressure stub to absorb gas into the Venturi tube. However this makes the cost high and no improvement to the functions of the Venturi tube.

### SUMMARY OF THE INVENTION

Accordingly, the primary object of the present invention is to provide a pressure-difference adjustable Venturi tube device, wherein the pressure difference of the inlet and outlet of the Venturi tube is adjustable to fit the requirement. Furthermore, the present invention has a control valve. The size of the injection opening is controlled by the control valve easily so that the pressure difference between the inlet and the outlet of the Venturi tube 1 is controllable according to the usage, environment, positions and input pressure.

To achieve above objects, the present invention provides a pressure-difference adjustable Venturi tube device which comprises a Venturi tube having an inlet, a hollow tapered compressing channel, an injection opening communicated to the compressing channel, a mixing chamber communicated to the injection opening, and an outlet communicated to the mixing chamber, which are sequentially arranged one by one; a negative pressure stub extended from the connection of the injection opening and the mixing chamber to a lateral side of the Venturi tube 1 so as to communicated to outer sides; and a control valve installed from the inlet of the Venturi tube to the distal end of the injection opening for controlling a tube size of the injection opening of the compressing channel. The control valve is one of an electric controlled and a manual controlled ball valve and other control element.

The various objects and advantages of the present invention will be more readily understood from the following detailed description when read in conjunction with the appended drawing.

### BRIEF DESCRIPTION OF THE DRAWINGS

FIG. 1 is one embodiment of the present invention.

FIG. 2 is a cross sectional view about the present invention.

FIG. 3 is a cross sectional view along line 3-3 of the present invention.

FIG. 4 is a schematic view showing the adjustment of the control valve of the present invention.

### DETAILED DESCRIPTION OF THE INVENTION

In order that those skilled in the art can further understand the present invention, a description will be described in the following in detail. However, these descriptions and the appended drawings are only used to cause those skilled in the art to understand the objects, features, and characteristics of the present invention, but not to be used to confine the scope and spirit of the present invention defined in the appended claims.

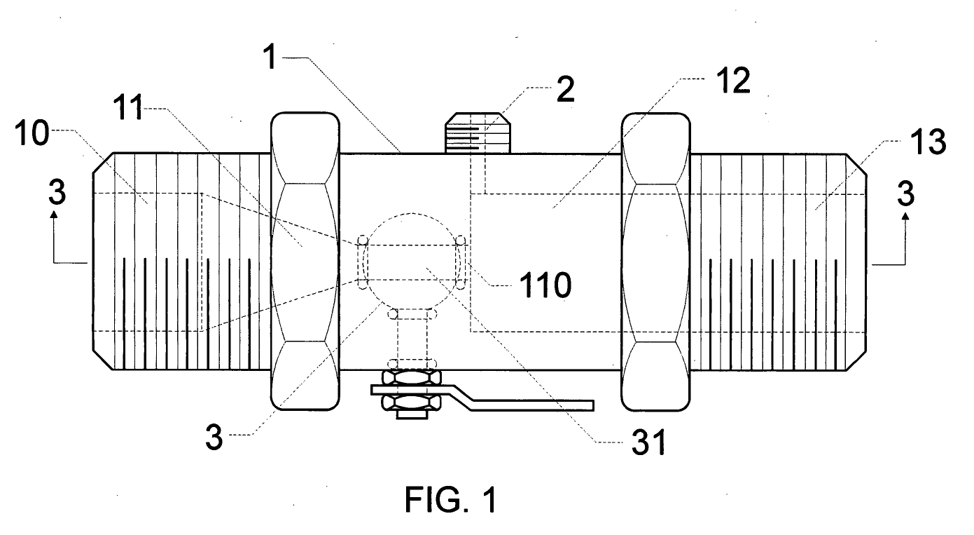

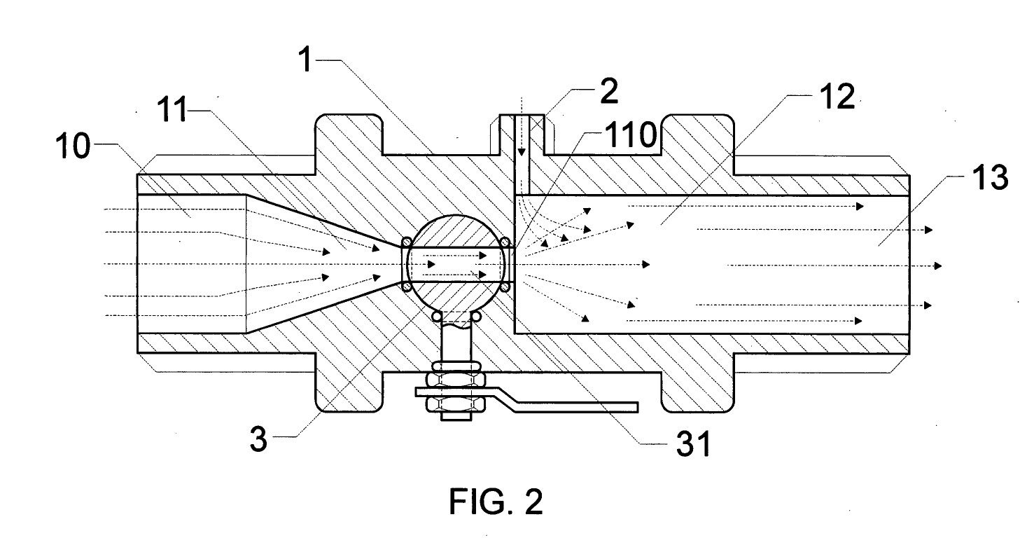

With reference to FIGS. 1 and 2, the structure of the present invention comprises the following elements.

A Venturi tube 1 has an inlet 10, a hollow tapered compressing channel 11, an injection opening 110 communicated to the compressing channel 11, a mixing chamber 12 communicated to the injection opening 110, and an outlet 13 communicated to the mixing chamber 12, which are sequentially arranged one by one.

A negative pressure stub is extended from the connection of the injection opening 110 and the mixing chamber 12 to a lateral side of the Venturi tube so as to communicated to outer sides.

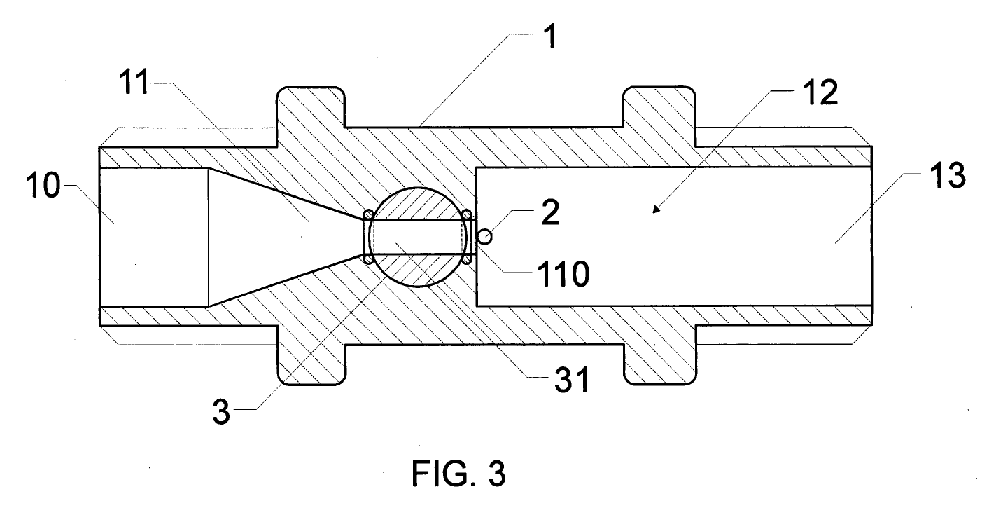

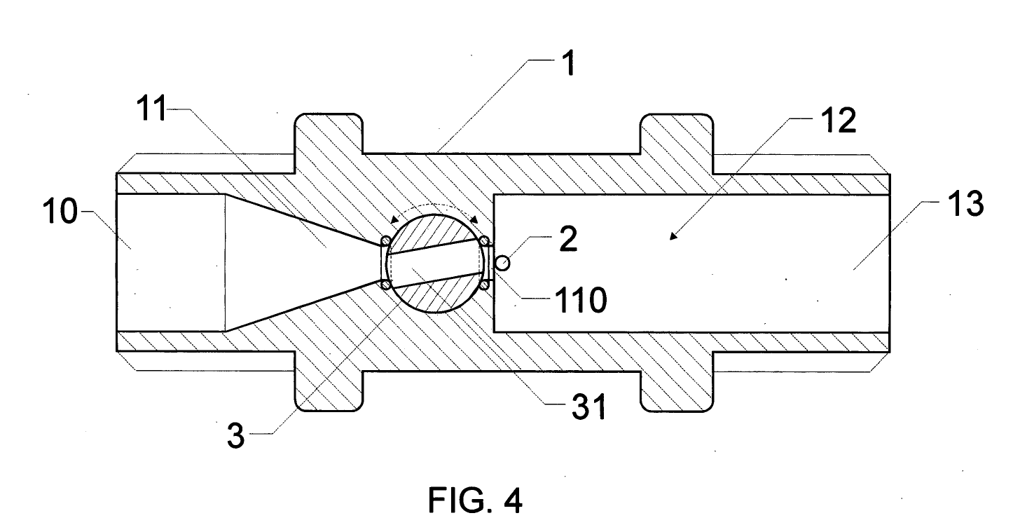

A control valve 3 is installed from the inlet 10 of the Venturi tube 1 to the distal end of the injection opening 110. The control valve 3 may be an electric controlled or a manual controlled ball valve or any control element (in the drawing, a manual control device is illustrated) which serves to control the tube size of the injection opening 110 of the compressing channel 11. By the rotation and displacement of the control valve 3, a penetrating channel 31 of the control valve 3 and the injection opening 110 of the compressing channel 11 are adjusted to be aligned or not aligned so as to control the tube size of the injection opening 110 (referring to FIGS. 3 and 4).

The advantages of the present invention will be described herein.

The size of the injection opening 110 is controlled by the control valve 3 easily so that the pressure difference between the inlet 10 and the outlet 13 of the Venturi tube 1 is controllable according to the usage, environment, positions and input pressure.

The negative pressure of the negative pressure stub 2 is well controlled by the control valve 3. Thereby the negative pressure stub 2 serves to absorb air, ozone, or other gas or liquid so as to have preferred performance and be economic.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pressure-difference adjustable Venturi tube device compising:
a Venturi tube having an inlet, a hollow tapered compressing channel, an injection opening communicated to the compressing channel, a mixing chamber communicated to the injection opening, and an outlet communicated to the mixing chamber, which are sequentially arranged one by one;
a negative pressure stub extended from the connection of the injection opening and the mixing chamber to a lateral side of the Venturi tube 1 so as to communicated to outer sides; and
a control valve installed from the inlet of the Venturi tube to the distal end of the injection opening for controlling a tube size of the injection opening of the compressing channel.

2. A pressure-difference adjustable Venturi tube device as claimed in claim 1, wherein the control valve is one of an electric controlled and a manual controlled ball valve.

3. A pressure-difference adjustable Venturi tube device as claimed in claim 1, wherein the control valve is a control element.
